(19) United States
(12) Patent Application Publication
(10) Pub. No.: US 2021/0348940 A1
(43) Pub. Date: Nov. 11, 2021

(54) NAVIGATION APPARATUS AND METHOD FOR OPERATING A NAVIGATION APPARATUS

(71) Applicant: Vestel Elektronik Sanayi ve Ticaret A.S., Manisa (TR)

(72) Inventor: Çaglar ÍSLEK, Manisa (TR)

(21) Appl. No.: 17/284,748

(22) PCT Filed: Oct. 12, 2018
(86) PCT No.: PCT/EP2018/077950

§ 371 Date: Apr. 12, 2021

(51) Int. Cl. G01C 21/36; G01C 19/00; G01S 19/01

(52) U.S. Cl. CPC G01C 21/3652; G01C 21/3667; G01S 19/01; G01C 19/00

(57) ABSTRACT

Navigation apparatus in which a current location and a current orientation of the navigation unit are determined. Navigation information data is generated based on navigation map data stored in a memory and the determined current location and the determined current orientation of the navigation apparatus. Navigation information is displayed by a display unit according to the generated navigation information data. The display unit also comprises an electrovibration system for generating electrovibrations to be sensed by a user touching the display unit depending on the generated navigation information data.

### TECHNICAL FIELD

The present disclosure relates to a navigation apparatus and a method for operating a navigation apparatus.

### BACKGROUND

A conventional navigation apparatus comprises a location determining unit for determining a current location of the navigation apparatus, an orientation determining unit for determining a current orientation of the navigation unit, a memory for storing navigation map data, a processor for generating navigation information data based on the navigation map data stored in the memory and the current location of the navigation apparatus determined by the location determining unit and the current orientation of the navigation apparatus determined by the orientation determining unit, a display unit comprising an electronic display for displaying navigation information according to the navigation information data generated by the processor, and a speaker for outputting navigation information according to the navigation information data generated by the processor.

Based on such a conventional navigation apparatus, there is a need for an improved navigation apparatus which can also be used in satisfactory manner by visually impaired people and in noisy environments.

### SUMMARY

According to a first aspect disclosed herein, there is provided a navigation apparatus comprising a location determining unit for determining a current location of the navigation apparatus, an orientation determining unit for determining a current orientation of the navigation unit, a memory for storing navigation map data, a processor for generating navigation information data based on the navigation map data stored in the memory and the current location of the navigation apparatus determined by the location determining unit and the current orientation of the navigation apparatus determined by the orientation determining unit, and a display unit comprising an electronic display for displaying navigation information according to the navigation information data generated by the processor. The display unit comprises an electrovibration system for generating electrovibrations to be sensed by a user touching the display unit, and the processor is configured to control the electrovibration system depending on the generated navigation information data.

By generating electrovibrations to be sensed by a user touching the display unit depending on the generated navigation information data, navigation information is provided in a haptic manner so that it can be recognized reliably also by visually impaired people. Further, the haptic navigation information can be easily detected also in noisy environments such as e.g. in crowded places or heavy traffic.

By using electrovibrations, virtual friction feeling can be given to a user touching the display unit. In case of a user's finger sliding over the display unit, a dynamic friction feeling is generated. Thus, using an electrovibration system for generating electrovibrations to be sensed by a user touching the display unit instead of a classic vibration actuator for generating vibrations of the entire navigation apparatus, provides a wider range of information to be presented in haptic manner.

Electrovibration systems do not require moving parts, are lightweight, and require little power. For this reason, electrovibration systems can advantageously be used in mobile navigation apparatuses.

The navigation apparatus may be in the form of a mobile phone, a smartphone, a tablet, a laptop computer, a navigation device, etc.

In an example, the electrovibration system of the display unit comprises a plurality of electrodes arranged next to each other which are controlled by the processor independently of each other. By this configuration, the electrovibrations can be generated in specific areas of the display unit and/or in various characteristics over the display unit.

In an example, the processor is configured such that the navigation information data generated by the processor includes routing data. In this case, the processor may be configured to control the electrovibration system to generate electrovibrations in an electrovibrating area of the display unit defined according to the routing data.

In an example, the navigation apparatus comprises a vibration actuator for generating vibrations of the navigation apparatus. In this case, the processor may be configured to control the vibration actuator depending on the generated navigation information data. The vibration actuator may be a classic vibration actuator for generating vibrations of the entire navigation apparatus.

In an example, the navigation apparatus comprises a vibration actuator for generating vibrations of the navigation apparatus, and the navigation information data generated by the processor includes routing data. In this case, the processor may be configured to control the vibration actuator to generate vibrations of the navigation apparatus depending on the generated navigation information data and the detected touching point. By this configuration, the vibration actuator may generate vibrations of the navigation apparatus for example when the current location of the navigation apparatus determined by the location determining unit is near a change in direction in the routing data.

In an example, the display unit is formed as a touch screen configured to detect a touching point of a user touching the display unit.

In an example, the navigation apparatus comprises a vibration actuator for generating vibrations of the navigation apparatus, and the display unit is formed as a touch screen configured to detect a touching point of a user touching the display unit. In this case, the processor may be configured to control the vibration actuator to generate vibrations of the navigation apparatus depending on the generated navigation information data and the detected touching point. By this configuration, the vibration actuator may generate vibrations of the navigation apparatus for example when the touching point detected by the touch screen corresponds to the current location of the navigation apparatus on a navigation map displayed on the display unit.

According to a second aspect disclosed herein, there is provided a method for operating a navigation apparatus comprising determining a current location of the navigation apparatus, determining a current orientation of the navigation unit, generating navigation information data based on navigation map data stored in a memory and the determined current location of the navigation apparatus and the determined current orientation of the navigation apparatus, and displaying navigation information according to the generated navigation information data by a display unit, wherein the display unit also generates electrovibrations to be sensed by a user touching the display unit depending on the generated navigation information data.

In an example, the display unit generates the electrovibrations by a plurality of electrodes independently of each other. The electrodes are arranged next to each other in the display unit.

In an example, the generated navigation information data also includes routing data, and the display unit generates electrovibrations in an electrovibrating area defined according to the routing data.

In an example, the method comprises generating vibrations of the entire navigation apparatus depending on the generated navigation information data.

In an example, the generated navigation information data also includes routing data, and the method comprises generating vibrations of the entire navigation apparatus depending on the generated navigation information data. In this configuration, the vibrations of the navigation apparatus may e.g. be generated when the determined current location of the navigation apparatus is near a change in direction in the routing data.

In an example, the method comprises detecting a touching point of a user touching the display unit.

In an example, the method comprises generating vibrations of the entire navigation apparatus depending on the generated navigation information data and detecting a touching point of a user touching the display unit, and the vibrations of the navigation apparatus are generated depending on the generated navigation information data and the detected touching point. In this configuration, the vibrations of the navigation apparatus may e.g. be generated when the detected touching point corresponds to the current location of the navigation apparatus on a navigation map displayed on the display unit.

### BRIEF DESCRIPTION OF THE DRAWINGS

To assist understanding of the present disclosure and to show how embodiments may be put into effect, reference is made by way of example to the accompanying drawings in which:

FIG. 1 shows schematically the configuration of an example of a navigation apparatus according to an embodiment of the present disclosure;

FIG. 2 shows schematically the configuration of an example of a display unit to be used in the navigation apparatus of FIG. 1 according to an embodiment of the present disclosure;

FIG. 3A illustrates schematically a first state of navigation information displayed by the navigation apparatus of FIG. 1 according to an embodiment of the present disclosure; and

FIG. 3B illustrates schematically a second state of navigation information displayed by the navigation apparatus of FIG. 1 according to an embodiment of the present disclosure.

### DETAILED DESCRIPTION

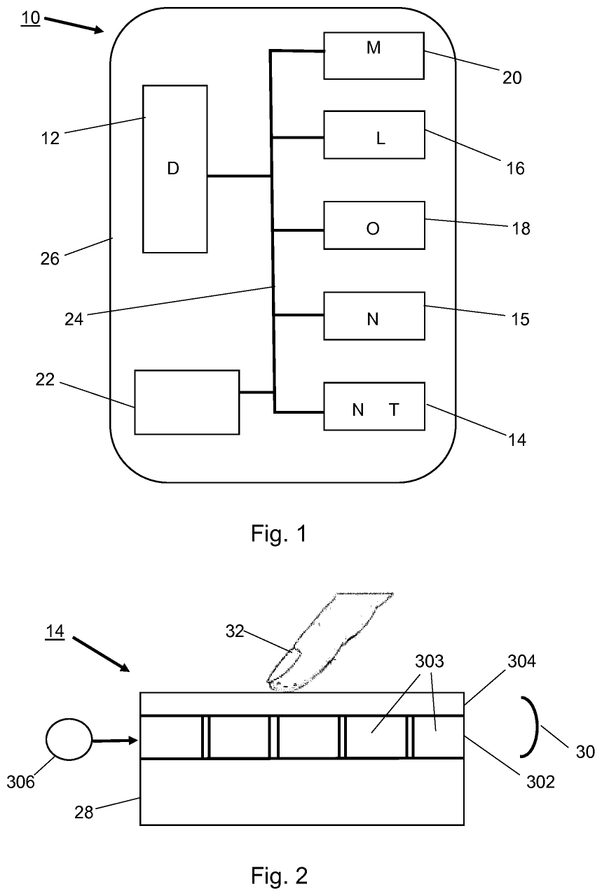

FIGS. 1 to 3 show an exemplary embodiment of a navigation apparatus according to the present disclosure in the form of a mobile phone or smartphone.

As exemplarily shown in FIG. 1, the navigation apparatus 10 comprises a processor 12, a display unit 14 (configured e.g. as a touch screen), a loudspeaker 15, a location determining unit 16 (configured e.g. as a GPS Global Positioning System or other location module), an orientation determining unit 18 (configured e.g. as a gyroscope) and a memory 20. In addition, the navigation apparatus 10 may optionally comprise a classic vibration actuator 22 for generating vibrations of the entire navigation apparatus 10. The display unit 14, the loudspeaker 15, the location determining unit 16, the orientation determining unit 18, the memory and the vibration actuator 22 are connected to the processor 12 via a data bus 24. All mentioned components 12-24 of the navigation apparatus 10 are arranged within a housing 26.

The location determining unit 16 is configured to determine the current location L of the navigation apparatus 10. The orientation determining unit 18 is configured to determine the current orientation O of the navigation apparatus 10. The current orientation O may in particular include the compass direction of the main apparatus axis and may further include the inclination of the apparatus relative to the ground surface.

Navigation map data M is stored in the memory 20. The navigation map data M may be downloaded e.g. from internet. The processor 12 generates navigation information data D based on the navigation map data M stored in the memory 20, the current location L of the navigation apparatus 10 determined by the location determining unit 16 and the current orientation O of the navigation apparatus 10 determined by the orientation determining unit 16. The display unit is configured to display navigation information N according to the navigation information data D generated by the processor 12. In addition, the speaker may be configured to output navigation information N according to the navigation information data D generated by the processor 12. The navigation information data D usually also includes routing data generated based on the navigation map data M and navigation target data input by the user. Similarly, the navigation information N displayed by the display unit 14 also includes routing information corresponding to the routing data.

If the display unit 14 is formed e.g. as a touch screen the display unit 14 can also be used to input data by a user. Further, the display unit 14 being formed as a touch screen is configured to detect a touching point T of a user touching the display unit 14.

As exemplarily illustrated in FIG. 2, the display unit 14 of the navigation apparatus 10 comprises an electronic display 28 for displaying the navigation information N. In addition, the display unit 14 comprises an electrovibration system 30 to generate electrovibrations which can be sensed by user 32 touching the display unit 14. The electrovibration system 30 comprises an electrically conductive layer 302, an insulating layer 304 and a power source 306. In the example of FIG. 2, the electrovibration system 30 is positioned on the side of the electronic display 28 facing towards the user. Therefore, the electrically conductive layer 302 and the insulating layer 304 are made at least partially transparent. Alternatively, the electrovibration system 30 may be positioned on the side of the electronic display 28 facing away from the user. In that configuration, the electronic display 28 is formed at least partially transparent and the insulation layer 304 may be omitted if the electronic display 28 is configured to be electrically isolating.

In this example, the electrically conductive layer 302 comprises a plurality of electrodes 303. These electrodes 303 are arranged next to each other and are isolated from each other to form an array of electrodes 303 connected individually to the power source 306. Thus, the plurality of electrodes 303 of the electrovibration system 30 can be controlled by the processor 12 independently of each other.

The electrovibration system 30 generates electrovibrations for giving a virtual friction feeling to a user 32 touching the display unit 14. This friction feeling results from electrostatic forces produced by the alternating voltage of the power source 306 across the electrically conductive layer 302 and the insulating layer 304. When a user 32 moves his/her finger over the display unit 14 (in the example of FIG. 2 over the insulating layer 304) the movement induces an electric force field between the finger 32 and the electrovibration system 30. Because of the alternating current provided by the power source 306, this force field also alternates to attract and repel the user's finger 32 so that the user 32 senses a virtual friction.

As the electrovibration principle as such is generally known, a more detailed explanation of the structure and the functionality of the electrovibration system 30 of the display unit 14 is omitted here. Also, it is to be noted that the navigation apparatus 10 disclosed herein is not limited to a special configuration of the electrovibration system 30 or to a special combination of the electrovibration system 30 with the electronic display 28 of the display unit 14.

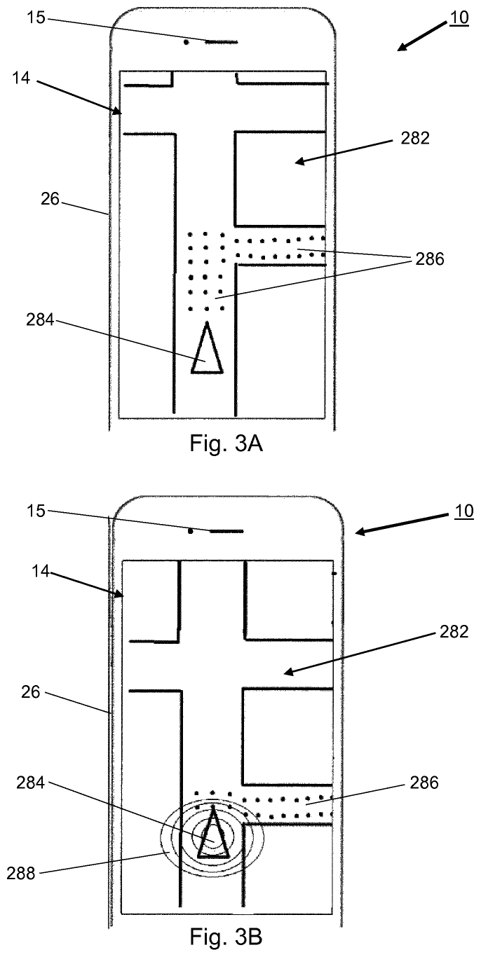

An example of the functionality of the navigation apparatus 10 according to the present disclosure is illustrated in FIGS. 3A and 3B.

As shown in FIGS. 3A and 3B, the navigation information N displayed by the electronic display 28 of the display unit 14 especially includes a navigation map 282 showing the section of the navigation map data M near the current location L of the navigation apparatus 10 and a location mark (e.g. an arrow-like mark) 284 showing the current location L of the navigation apparatus 10 determined by the location determining unit 16 on the navigation map 282. The direction of the arrow of the location mark 284 is synchronized with the current angle of sight of the user or the current orientation O of the navigation apparatus 10. The navigation map 282 is rotated with change of this orientation O.

Further, the routing information is not only displayed visually on the navigation map 282 but also marked by an electrovibrating area 286. In this electrovibrating area 286, the electrodes 303 of the electrovibration system 30 are activated by the processor 12 to generate electrovibrations as explained above. As a result, the user can recognize the routing information on the display unit 14 in a haptic manner. Thus, the routing information can also be recognized by visually impaired people and in noisy environments affecting the audible output of the routing information by the loudspeaker 15.

By the above explained configuration of the electrovibration system 30 having a plurality of electrodes 303 arranged next to each other, the electrovibrations can be varied over the display unit. As a result, the electrovibrations can be generated only in selected electrovibrating areas of the display unit 14, if appropriate. Additionally or alternatively, the electrovibrations can be generated in different intensities over the display unit, if appropriate.

For better support of the user, the navigation apparatus 10 of the present disclosure also uses a classic vibration actuator 22, that is an electrically drive mechanical vibration actuator, for generating vibrations of the entire navigation apparatus 10.

In the example of FIG. 3A, this vibration actuator 22 may be used to generate vibrations when the touching point T of a user 32 touching the display unit 14 is in the region of the location mark 284. As a result, the user recognizes that he/she has his/her finger at the location mark 284 corresponding to the current location L of the navigation apparatus 10 and that the routing information should be starting near the current touching point of his/her finger.

In the example of FIG. 3B, the vibration actuator 22 may be used to generate vibrations when the current location L of the navigation apparatus 10 determined by the location determining unit 16 is near a change in direction in the routing data. In FIG. 3B, this situation is illustrated by a vibration occurrence area 288 defined by the location mark 284 being near the next change in direction of the routing information. The vibrations of the navigation apparatus 10 call attention of the user to look at the display unit 14 to get information about the next change in direction of the routing information. Then, the location mark 284 and the routing information can be recognized in the same way as discussed above.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A navigation apparatus, comprising:
a location determining unit for determining a current location of the navigation apparatus;
an orientation determining unit for determining a current orientation of the navigation unit;
a memory for storing navigation map data;
a processor for generating navigation information data based on the navigation map data stored in the memory and the current location of the navigation apparatus determined by the location determining unit and the current orientation of the navigation apparatus determined by the orientation determining unit; and
a display unit comprising an electronic display for displaying navigation information according to the navigation information data generated by the processor,
wherein the display unit comprises an electrovibration system for generating electrovibrations to be sensed by a user touching the display unit; and
the processor is configured to control the electrovibration system depending on the generated navigation information data.

2. The navigation apparatus according to claim 1, wherein
the electrovibration system of the display unit comprises a plurality of electrodes arranged next to each other; and
the processor is configured to control the electrodes of the electrovibration system independently of each other.

3. The navigation apparatus according to claim 1, wherein
the processor is configured such that the navigation information data generated by the processor includes routing data; and
the processor is configured to control the electrovibration system to generate electrovibrations in an electrovibrating area of the display unit defined according to the routing data.

4. The navigation apparatus according to claim 1, wherein
the navigation apparatus comprises a vibration actuator for generating vibrations of the navigation apparatus; and
the processor is configured to control the vibration actuator depending on the generated navigation information data.

5. The navigation apparatus according to claim 1, wherein
the display unit is formed as a touch screen configured to detect a touching point of a user touching the display unit.

6. The navigation apparatus according to claim 5, wherein
the processor is configured to control the vibration actuator to generate vibrations of the navigation apparatus depending on the generated navigation information data and the detected touching point.

7. A method for operating a navigation apparatus, comprising:
determining a current location of the navigation apparatus;
determining a current orientation of the navigation unit;
generating navigation information data based on navigation map data stored in a memory and the determined current location of the navigation apparatus and the determined current orientation of the navigation apparatus; and
displaying navigation information according to the generated navigation information data by a display unit,
wherein the display unit also generates electrovibrations to be sensed by a user touching the display unit depending on the generated navigation information data.

8. The method according to claim 7, wherein
the display unit generates the electrovibrations by a plurality of electrodes independently of each other.

9. The method according to claim 7, wherein
the generated navigation information data also includes routing data; and
the display unit generates electrovibrations in an electrovibrating area defined according to the routing data.

10. The method according to claim 7, comprising:
generating vibrations of the navigation apparatus depending on the generated navigation information data.

11. The method according to claim 9, wherein
the vibrations of the navigation apparatus are generated when the determined current location of the navigation apparatus is near a change in direction in the routing data.

12. The method according to claim 7, comprising:
detecting a touching point of a user touching the display unit.

13. The method according to claim 10, wherein
the vibrations of the navigation apparatus are generated depending on the generated navigation information data and the detected touching point.

14. The method according to claim 13, wherein
the vibrations of the navigation apparatus are generated when the detected touching point corresponds to the current location of the navigation apparatus on a navigation map displayed on the display unit.
